(19) United States
(12) Patent Application Publication
(10) Pub. No.: US 2012/0269595 A1
(43) Pub. Date: Oct. 25, 2012

(54) CARGO DUNNAGE APPARATUS

(75) Inventor: Neville Fox, Bibra Lake (AU)

(73) Assignee: THE GLUTT COMPANY PTY LTD, Bibra Lake, W.A. (AU)

(21) Appl. No.: 13/514,799

(22) PCT Filed: Dec. 8, 2010
(86) PCT No.: PCT/AU2010/001654

§ 371 Date: Jul. 10, 2012

(30) Foreign Application Priority Data
Dec. 9, 2009 (AU) 2009906008
May 24, 2010 (AU) 2010902250

(51) Int. Cl. B60P 7/06

(52) U.S. Cl. 410/121

(57) ABSTRACT

A cargo dunnage apparatus (10) for supporting, securing and protecting cargo and packaging whilst the cargo is in transit or storage. The cargo dunnage apparatus (10) comprises an elongate support member (12) having a first end (14) and a second end (16). The support member (12) having a load bearing upper portion (20) arranged to receive cargo. Preferably the support member (12) further comprises at least one reinforcement member to increase the cargo carrying capacity of the apparatus (10) and cargo locating member for positioning and secure the cargo in use.

### BACKGROUND OF THE INVENTION

The present invention relates to a cargo dunnage apparatus.

The term Dunnage is used to refer to packing materials used to stabilise, secure and protect cargo and packaging whilst in storage and transportation.

Traditionally various kinds of materials are used as dunnage ranging from rice matting, plastic film, wooden off-cuts, and brushwood to more sophisticated rubber or plastic air bags. In use dunnage is packed between the cargo in order to ensure accessibility and minimise movement of the cargo during storage and transport and in turn preventing possible damage to the cargo from chafing, rubbing or knocking other cargo. Similarly, transport means of land, sea and air all employ dunnage to prevent the movement of cargo that may result in a corresponding damage or depreciation to the transport container or transport means being used.

Presently dunnage is generally seen as a consumable material and is often discarded after use. This practice is wasteful and leads to potential environmental and ecological issues with foreign insects frequently hidden amidst some dunnage materials and being transported along with the cargo. Customs restrictions addressing such concerns impact on international trade with fumigation and/or quarantine on imported wood (such as the wood used as dunnage during transport) requiring cargo ships to store unused dunnage materials on board. Problems are compounded when ships jettison old dunnage at sea by adding potential accidents to environmental and ecological risks. Similarly traditional wooden or other organic dunnage materials may have their structural integrity compromised by insects living in or near the dunnage and using it as a food source. This is particularly relevant where cargo is transported or stored over long periods of time. Compromised integrity of dunnage materials can lead to unsafe working environments as well as potential damage to the cargo itself from failure of the dunnage material structural integrity.

The present invention attempts to overcome, at least in part, the aforementioned disadvantages of previous methods of stabilising and supporting items of cargo during transit and storage.

### SUMMARY OF THE INVENTION

In accordance with one aspect of the present invention there is provided a cargo dunnage apparatus, for stabilizing and supporting cargo during transit or storage, characterised in that the apparatus comprises an elongate support member having a length along a longitudinal axis between a first end and a second end, the support member having a load bearing upper portion and a lower surface, wherein the upper portion is arranged to receive cargo.

Preferably the support member comprises reinforcement means and is arranged to receive a cargo locating means and a dunnage alignment means.

### BRIEF DESCRIPTION OF THE DRAWINGS

The present invention will now be described, by way of example, with reference to the accompanying drawings, in which:

FIG. 1 is an upper perspective view of a preferred embodiment of a support member of a cargo dunnage apparatus of the present invention;

FIG. 2 is an end view of a support member of FIG. 1;

FIG. 3 is a perspective view of a preferred arrangement using a plurality of support members of FIG. 1;

FIG. 4 shows an upper perspective view of a preferred embodiment of a cargo locating means of the cargo dunnage apparatus of FIG. 1;

FIG. 5 is a lower perspective view of the cargo locating means of FIG. 4;

FIG. 6 is an alternative embodiment of support member having cargo locating means and dunnage alignment means; and

FIG. 7 is an upper perspective view of the cargo dunnage apparatus of FIG. 6 in use.

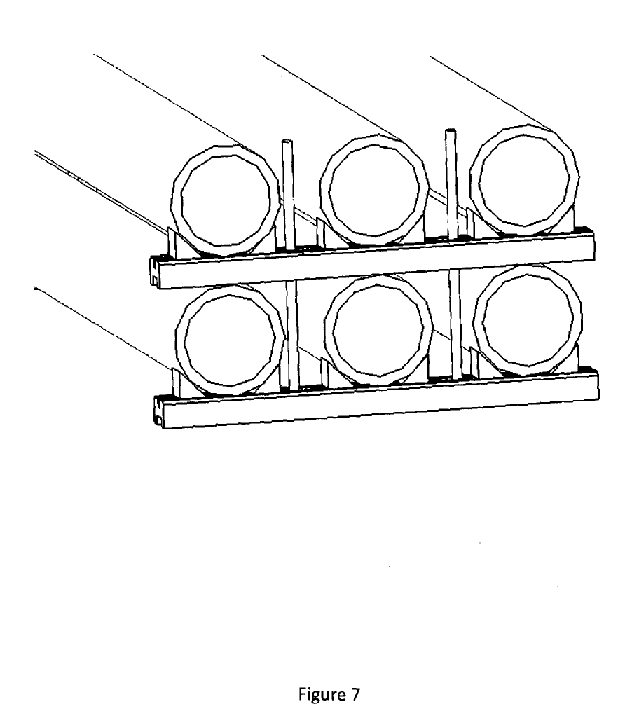

### DETAILED DESCRIPTION

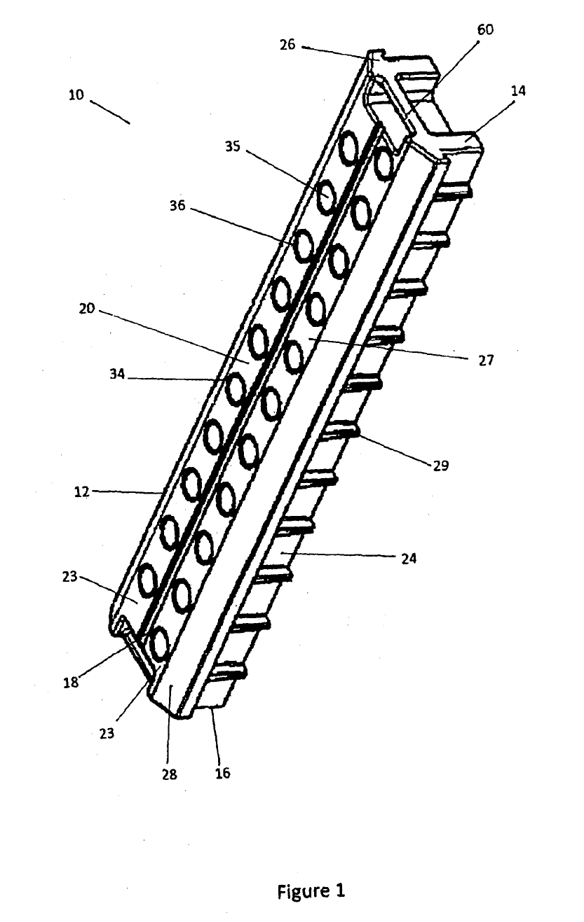

Referring to FIG. 1, there is shown a cargo dunnage apparatus 10 comprising at least a support member 12. In a preferred embodiment of the present invention the support member 12 comprises an elongate upper portion 20 extending along a longitudinal axis between a first end 14 and a second end 16. The upper portion 20 being further defined by side portions 24 and 25.

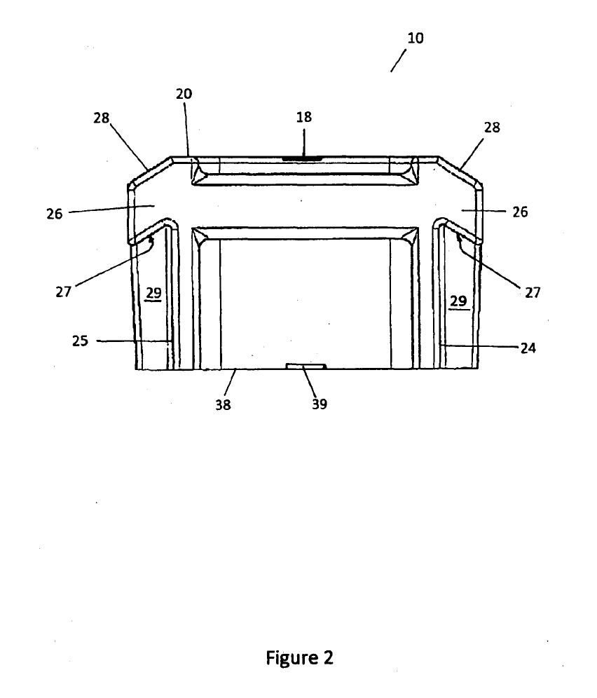

As seen in a preferred embodiment of the present invention shown in FIG. 1 the support member 12 comprises side portions 24, 25. The side portions 24, 25 define a width of a lower surface 38 (see FIG. 2) extending between the first end 14 and the second end 16.

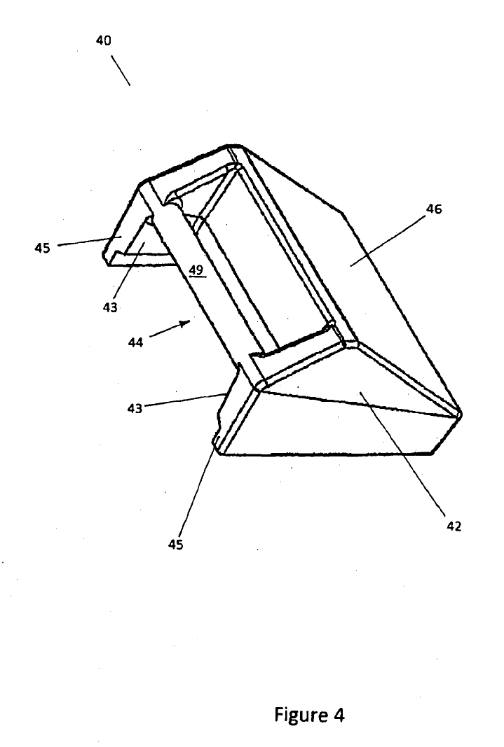

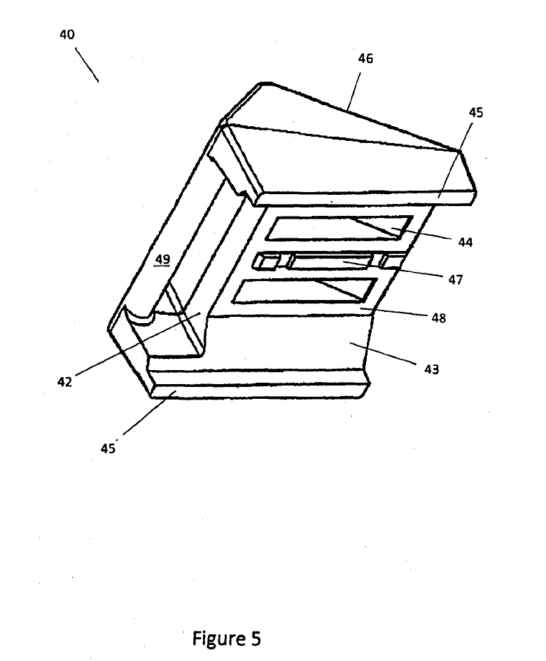

As seen in FIGS. 1 and 2 in a preferred embodiment of the present invention the upper portion 20 has a contoured cross-sectional profile arranged to receive a cargo locating means 40 (seen in FIGS. 4 and 5) providing at least a channel 18 spacing apart and separating respective load bearing upper surfaces 23. The channel 18 having a depth substantially recessed into the upper portion 20 and extending substantially along a length of the upper portion 20. Preferably the channel 18 may be arranged to receive at least a ferrous metallic strip (not shown).

Preferably the channel 18 may be used to position a strip member (not shown). Preferably the strip member comprises a non slip material such as for example rubber, and may be reversibly secured by known means. It is to be understood that the strip member provides a non-slip surface which projects outwardly from the upper portion 20. The strip member limits any slippage of for example a cargo or adjacent support member 12 in contact with the strip member.

Similarly, as seen in FIG. 2, a preferred embodiment of the present invention may comprise a lower surface 38 having a lower longitudinal channel 39. It is to be understood the lower channel 39 may also be used to position a strip member (not shown).

As in the upper position 20 channel 18, the lower channel 39 may be used to reversibly secure the strip member providing a non-slip surface projecting outwardly form the lower surface 38 to limit slippage of the cargo dunnage apparatus 10.

In a preferred embodiment of the present invention the upper portion 20 is arranged to have at least one, and preferably two, lateral angled faces 28. As can be seen from FIGS. 1 and 2 the angled faces 28 provide a substantially flat surface extending along at least a portion of the longitudinal length of the upper surface 20. In the present embodiment the respective angled faces 28 extend laterally beyond the side portions 24, 25 providing respective flanges 26. Preferably, a plurality of reinforcement lugs 29 are spaced along and extend outwardly from side portions 24, 25. The lugs 29 being in communication with a lower surface 27 of flange 26. It is to be understood that the lugs 29 are arranged to provide a load bearing support to the flanges 26.

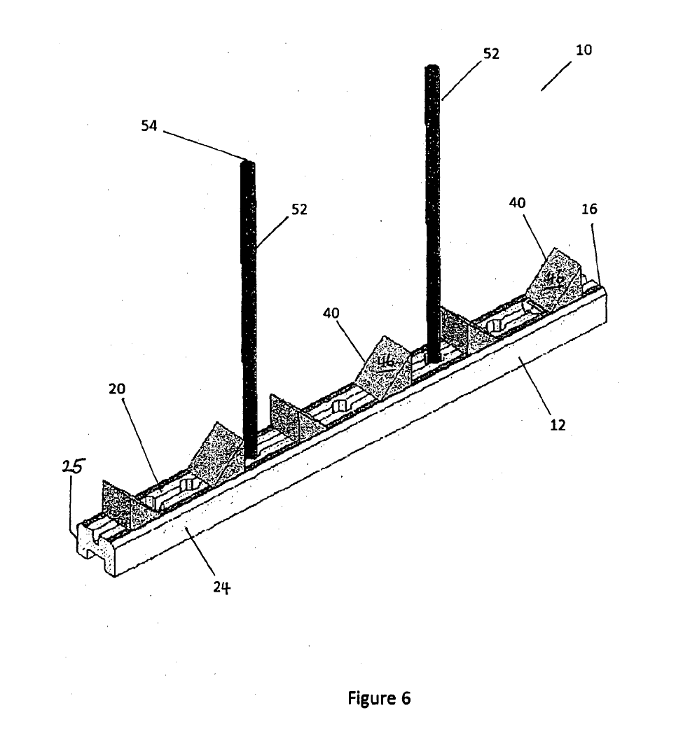

Further, in a preferred embodiment of the present invention it is envisaged the support member 12 has provision of a cargo locating means. Preferably the cargo locating means comprises at least one wedge member 40 as can be seen in FIGS. 4, 5 and 6.

As shown in FIGS. 4 and 5 a preferred embodiment of a wedge member 40 comprises a body portion 42 having an internal substantially hollow portion 44. The wedge member 40 further comprises a base portion 48 (FIG. 5) and at least one upper inclined plane portion 46. It is to be understood that a permanent magnet (not shown) will preferably be securely housed within the body portion 42 and arranged to have at least a flat surface coplanar with the base portion 48 and in use adjacent to support member 12 channel 18.

The base portion 48 is further arranged to have at least one and preferably two base flange portions 45 projecting downwardly from the base portion 48. It is to be understood that the base flange portions 45 are arranged to have at least one angled surface 43 complementary to angled faces 28, thereby limiting a lateral movement of a wedge member 40 in use. Typically, in use, the base flange portions 45 may communicate with the angled faces 28 thereby at least in part straddling the support member 12. A preferred embodiment further comprises a base portion 48 having a protuberance 47 (FIG. 5) dimensioned to be received, at least in part, within the upper channel 18. Preferably the wedge member 40 may be arranged with a handle 49. The handle 49 being dimensioned to allow an operator to move and adjust the position of the wedge member 40 when in position on a support member 12.

In the preferred embodiment of the present invention shown in FIG. 1 the reinforcement means comprises a plurality of metallic members 34 substantially housed within a casing 37 and forming an integral portion of the support member 12. The metallic members 34 are arranged to be substantially upstanding and extend throughout a depth of the support member 12. The depth of the support member measured as being substantially between the support member 12 upper load bearing surfaces 23 and a lower surface 38. It is to be understood that the metallic members are arranged to directly support a load between the upper surface 23 and the lower surfaces 38.

Preferably metallic members 34 may have respective exposed peripheral ends 36 coplanar with the upper load bearing surfaces 23 and lower surface 38. Preferably the metallic members 34 may comprise a rigid tubular material such as for example aluminium, and be individually spaced apart and along the length of the upper surface 20, thereby providing a plurality of lumens 35 as seen in FIG. 1. It is to be understood that the metallic members 34 assume a load bearing function for supporting a cargo in use and thereby increase a cargo carrying capacity of the cargo dunnage apparatus 10.

Preferably the support member 12 is arranged to receive dunnage alignment means. The dunnage alignment means with at least an alignment member 52 comprising a rod, preferably cylindrical, having an outer diameter and peripheral ends 54. In use, a plurality of alignment members 52 may be arranged to pass through vertically aligned lumens 35 thereby allowing the cargo dunnage apparatus 10 to be used in layers and effectively sandwiching a cargo as can be seen in Figure V.

In an alternate embodiment (not shown) the reinforcement means comprises at least one, and preferably two alternate metallic members 34 (not shown) substantially housed within the casing 37 and forming an integral portion of the support member 12. The metallic members 34 may be arranged to extend substantially along the length of the support member 12 and have respective exposed upper metal surfaces 36 coplanar with the load bearing surfaces 23. It is to be understood that such metallic members 34 assume a load bearing function thereby increasing a cargo carrying capacity of the cargo dunnage apparatus 10.

In other embodiments the metallic members 34 may be removably attached to the reinforcement means and removed or replaced as desired.

Furthermore, as can be seen in FIG. 1 it is envisaged that the dunnage apparatus 10 will have provision of at least one, and preferably two, handles 60. Preferably a handle 60 may be a moulded portion of support member 12 and arranged to aid in the physical movement of the support member 12 by an operator using the cargo dunnage apparatus 10. Preferably the handle 60 may be positioned proximal to ends 14, 16.

It is to be understood the handle 60 may also be used as an anchor point for securing the dunnage apparatus 10 to a cargo, a transport or a storage platform by known means using ropes, straps etc for example.

A preferred embodiment of the present invention comprises a locking pin 50. Preferably locking pin device 50 comprises a substantially cylindrical body (not shown) having an outer diameter, a first end and second end. It is to be understood the locking pin 50 may be dimensioned to be received into a lumen 35. Preferably a first end of the locking pin 50 is provided with a cap portion 51 providing a lip (not shown) arranged to abut and in use be seated on the metallic member 34.

Preferably the second end of the locking pin 50 may have provision of an ‘O’-ring. Preferably the ‘O’-ring may be positioned in a groove formed in the body of the locking pin 50. It is to be understood that in use the ‘0’-ring is dimensioned to provide a friction fit between the locking pin 50 and a lumen 35 thereby securing the locking pin 50 within the lumen 35. Alternate embodiments may comprise other known means to removably secure a locking pin 50 within a lumen 35.

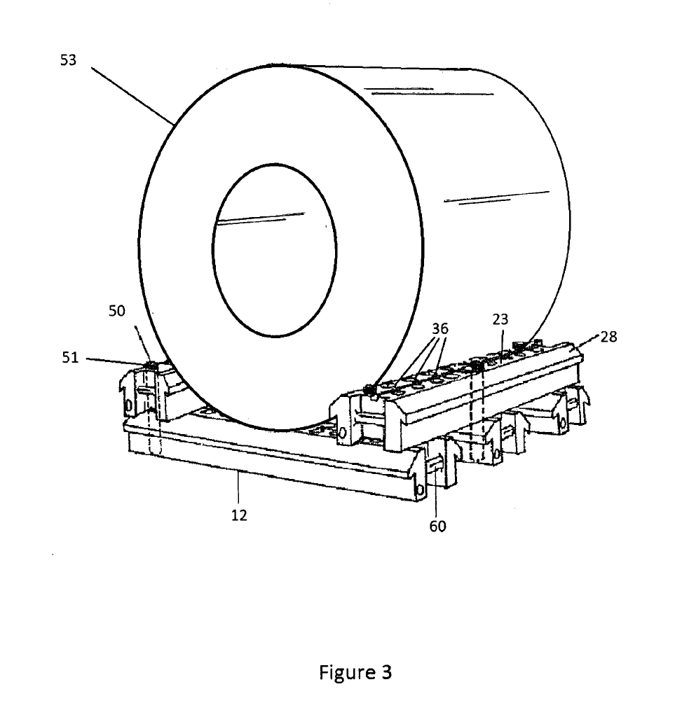

It is envisaged that in at least one embodiment of the locking pin 50, the cylindrical body may have a length substantially greater than a depth of the support member 12. In use the locking pin 50 may be used to connect two or more support members 12 about a plurality of respectively aligned lumens 35. This arrangement enables the support members 12 to be used to form, for example, a cargo cradle as seen in FIG. 3.

In the arrangement shown in FIG. 3, it can be seen that the angled face 28 may be used to locate the cargo upon a support member 12. It is to be understood that different embodiments of the support member 12 may be arranged to have different cross sectional areas being otherwise substantially similar in relative proportions to embodiments of the support member 12 as used in combination with the wedge members 40.

As can be seen in FIG. 3 a plurality of support members 12 may be removably attached to one another using the locking pin 50. In this arrangement it can be seen that actual cargo movement (roll) is limited by a plurality of upper support members 12. It is to be understood that a dead weight of a cargo member 53 is supported by a plurality of lower support members 12 arranged to be substantially perpendicular to the adjacent upper support members 12.

It is to be understood that various other combinations, configurations and arrangements (not shown) of the cargo dunnage apparatus 10 may be possible.

Similarly it is envisaged a further preferred embodiment (not shown) of the dunnage apparatus 10 of the present invention may comprise a support member 12 for use as a spacer. Preferably a support member 12 used as a spacer may comprise a simple geometric cross sectional area such as a square, oblong or trapezoidal shape for example. Preferably such a support member 12 may have reinforcement means.

It is to be understood that different embodiments of the support member 12 may have progressive reductions in cross sectional area compared with a full sized support member 12. The lengths of the different embodiments of the support member 12 may be substantially similar to one another or differ according to the requirements needed for any particular cargo, transportation or storage platform. For example a support member 12 used in a container may have a length less than a width of the container. Further, the length of a support member 12 used in a container may be different to a support member 12 used, for example, in road transport or rail transport.

The materials used in construction of the support member 12 will have suitable strength and durability characteristics to maximise a useful life of the cargo dunnage apparatus 10 of the present invention. Preferably the support member 12 will be a plastic polymer material. Preferably the cargo dunnage apparatus 10 may comprise a high visibility colour, preferably having different high visibility colours for the support member 12, the wedge 40 and the alignment means 52. At least a surface 27 of the cargo dunnage apparatus 10 may be finished to provide for a non-slip texture thereby minimising the likelihood of a cargo sliding along the dunnage apparatus 10 as well as minimising the apparatus 10 from sliding on, for example, a transportation platform.

In a preferred embodiment of the present invention the support member 12 may have an identification means (not shown) such as, but not limited to, an RFID chip. The chip would preferably be removable and located on or in the support member 12 to allow ease of identification for tracking and stock keeping of the apparatus 10 by known means simply by scanning the identification means.

The use of the cargo dunnage apparatus 10 may vary depending on the cargo to be transported. With cargo having an arcuate outer surface such as coiled metal sheet or piping for example, a plurality of support members 12 are arranged in a cargo hold or other transportation platform (not shown) and cargo is placed thereon typically with the aid of a crane or other lifting device as is known in the art. When the cargo is in a desired position one or more wedge members 40 are placed on the support member 12 upper portion 20, and arranged to have the upper inclined surface 46 in communication with the cargo thereby preventing slippage or rolling. Alternatively, the support members 12 may be fitted with one or more wedge members 40 at a predetermined position prior to the cargo being placed onto the support member 12. It is to be understood that the support member 12 is arranged to substantially support the weight of the cargo whereas the wedge member 40 is arranged to limit movement of the cargo when in position upon the support members 12.

In use, a support member 12 may be placed between items of cargo to space apart and separate layers of the cargo thereby allowing an operator to place, for example, a sling or fork lift tine for lifting, beneath the cargo to permit ease of removal or realignment of the cargo layer as is known in the art.

It is to be appreciated that due to the surface texture and the magnetic communication between the wedge member 40 and the support member 12, that the wedge member 40 will not slide freely along the upper portion 20, particularly when a portion of the cargo weight is bearing upon the inclined surface 46.

Preferably a plurality of grommets (not shown) arranged to be received at least in part into a lumen 35 may also be used to improve the stability of the cargo dunnage apparatus 10 of the present invention. It is envisaged the grommets may comprise a suitable non-slip substance such as for example rubber and may be arranged in any combination on the apparatus 10. It is to be understood that the grommet may provide a flexible and resilient surface used to limit slippage of the apparatus in use.

It is to be further understood that the present invention may be used in conjunction with any other traditional method of securing cargo such as chains, ropes and straps etc. as is known in the art, which will further secure multiple apparatus 10 together and/or the cargo to a transportation or a storage platform.

Modifications and variations as would be apparent to a skilled addressee are deemed to be within the scope of the present invention.

1-20. (canceled)

21. A cargo dunnage apparatus, for stabilizing and supporting cargo during transit or storage, the cargo dunnage apparatus comprises an elongate support member having a length along a longitudinal axis between a first end and a second end, the elongate support member having a load bearing upper portion and a lower surface, the upper portion is arranged to receive cargo, the elongate support member having reinforcement means comprising a metallic member, wherein the metallic member is of an upstanding tubular configuration.

22. A cargo dunnage apparatus according to claim 21, wherein the elongate support member is arranged to receive a cargo locating means.

23. A cargo dunnage apparatus according to claim 22, wherein the cargo locating means comprises a wedge member.

24. A cargo dunnage apparatus according to claim 21, wherein the elongate support member is arranged to receive dunnage alignment means.

25. A cargo dunnage apparatus according to claim 21, wherein the elongate support member comprises a ferromagnetic portion.

26. A cargo dunnage apparatus according to claim 23, wherein the wedge member comprises a magnet.

27. A cargo dunnage apparatus according to claim 23, wherein the wedge member comprises, at least in part, a surface complementary to a cargo.

28. A cargo dunnage apparatus according to claim 24, wherein the dunnage alignment means comprises at least an alignment member.

29. A cargo dunnage apparatus according to claim 28, wherein the alignment member comprises a rod.

30. A cargo dunnage apparatus according to claim 21, wherein the elongate support member comprises an identification means.

31. A cargo dunnage according to claim 30, wherein the identification means comprises a RFID chip.

32. A cargo dunnage according to claim 21, wherein the elongate support member comprises a handle.

33. A cargo dunnage according to claim 21, wherein the elongate support member is arranged to receive a locking pin.

34. A cargo dunnage according to claim 33, wherein a length of the locking pin is greater than a depth of the elongate support member.

35. A cargo dunnage according to claim 21, wherein the length of the elongate support member is arranged to be complementary to a storage or transportation platform.

36. A cargo dunnage according to claim 21, wherein the elongate support member comprises a cross section having a square configuration.

37. A cargo dunnage according to claim 21, wherein the elongate support member comprises a cross section having an oblong configuration.

38. A cargo dunnage according to claim 21, wherein the elongate support member comprises a cross section having a trapezoidal configuration.

39. A method for operating a cargo dunnage apparatus, wherein the apparatus comprises an elongate support member having a longitudinal axis between a first end and a second end, the elongate support member having a load bearing upper portion arranged to receive a cargo and a locking pin, comprising the steps of reversibly connecting together a plurality of support members and arranging the support members to support and restrain a cargo from movement during transport or storage.
